(19) United States
(12) Patent Application Publication
(10) Pub. No.: US 2026/0071879 A1
(43) Pub. Date: Mar. 12, 2026

(54) ROAD POSITION DETERMINATION WITH CONNECTED VEHICLE INFORMATION

(71) Applicant: International Business Machines Corporation, Armonk, NY (US)

(72) Inventors: Hideyuki Mizuta, Tokyo (JP); TAKUYA OKADA, Tokyo (JP); Manabu Matsui, Chiba (JP); Satoshi Uchida, Tokyo (JP); Shinya Kato, Tokyo (JP); Kosuke Lida, Yokohama City (JP)

(21) Appl. No.: 18/826,476

(22) Filed: Sep. 6, 2024

(51) Int. Cl. G01C 21/28; G01C 21/36; H04W 4/46

(52) U.S. Cl. CPC G01C 21/28; G01C 21/36; H04W 4/46

(57) ABSTRACT

A method, computer system, and a computer program product are provided for determining precise location of a target vehicle dynamically. Data relating a target vehicle is obtained to determine the target vehicle's position and route. The data relates to said target vehicle's speed and general moving and directional position. An estimate is calculated based on information about target vehicle movement using speed and traffic congestion and based on position of the target vehicle. Information is obtained about movement of a plurality of other vehicles in proximity of the target vehicle. An elapsed time difference is determined between progress of movement of said target vehicle and a real-time progress of said plurality of vehicles progress. An effectiveness estimate is calculated and the target vehicle's precise position is determined based on the effectiveness estimate.

### BACKGROUND

The present invention relates generally to data management and more particularly to techniques for determining road position connected to a vehicle.

Determination of a vehicle positioning has become more important in recent years. Different applications have been developed that link vehicle location information to data that relies on positioning. For example, Connected Vehicle Insight (CVI) is an application that link vehicle location information and provide the vehicle navigational information.

Unfortunately, in congested areas such as busy urban areas, navigational information may be provided incorrectly. This is because there is too much overlapping roads in these areas my impact accuracy. In addition, in many urban areas the road network is complicated that increases the challenges in providing error free results.

### SUMMARY

Embodiments of the present invention disclose a method, computer system, and a computer program product for determining precise location of a target vehicle dynamically. Data relating a target vehicle is obtained to determine the target vehicle's position and route. The data relates to said target vehicle's speed and general moving and directional position. An estimate is calculated based on information about target vehicle movement using speed and traffic congestion and based on position of the target vehicle. Information is obtained about movement of a plurality of other vehicles in proximity of the target vehicle. An elapsed time difference is determined between progress of movement of said target vehicle and a real-time progress of said plurality of vehicles progress. An effectiveness estimate is calculated based on the elapsed time difference and a time difference between the target vehicle real-time progress and one or more previous recorded historical data time-stamp(s). The said target vehicle's precise position is then determined based on the effectiveness estimate.

### BRIEF DESCRIPTION OF THE SEVERAL VIEWS OF THE DRAWINGS

These and other objects, features and advantages of the present invention will become apparent from the following detailed description of illustrative embodiments thereof, which may be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for techniques for determining precise location of a target vehicle; according to one embodiment;

FIG. 3 provides a block diagram illustrating positional location of a vehicle, according to one embodiment; and

FIG. 4 provides a block diagram, illustrating vehicles using different methods for receiving dynamic data, according to one embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

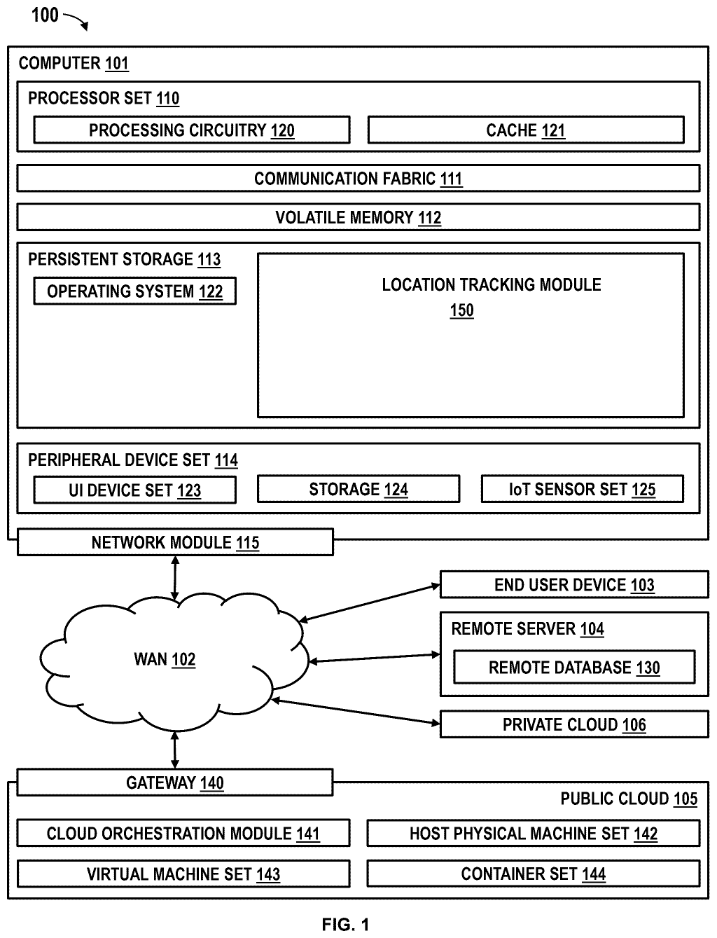

FIG. 1 provides a block diagram of a computing environment 100. The computing environment 100 contains an example of an environment for the execution of at least some of the computer code involved in performing the inventive methods, such as code change differentiator which is capable of providing Location Tracking 150. In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As explained earlier, the reliance on applications that provide data based on vehicle location and future navigation has increased. One such application, for example, is Connected Vehicle Insight (CVI). The technology used in CVI is similar to many other applications but CVI is used as an example for ease of understanding. CVI and other such similar applications link vehicle location information so that the current vehicle location obtained in real-time, including the road information that the vehicle is traveling on, can e provided. However, in many instances, such as in congested or urban areas, this information is often incorrectly estimated. This causes a negative impact on the aggregated road data and algorithms that provide later-stage services.

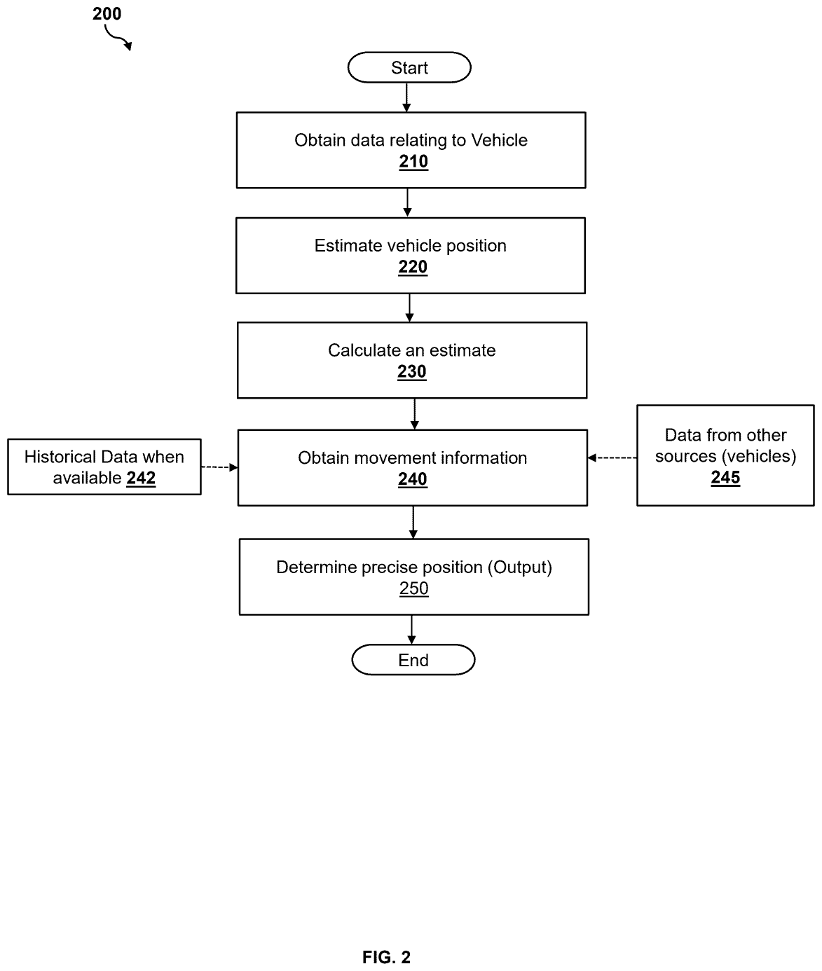

In a CVI type application, a vehicle's navigation route (road) is estimated from the latitude and longitude information obtained from the vehicle and map data. However, especially in urban areas, the road network is very complicated (there are different roads in close proximity), and GPS data often contains large errors. In FIG. 2, a process 200 is provided that addresses these issues as will be discussed.

Process 200 starts with Step 210. In this step, in an embodiment, data relating to a target vehicle is obtained. In one example, this data can be obtained from a real-time probe (data) of a target vehicle.

In Step 220, an estimate of the vehicle's position is calculated and related information generated. In addition, possibility of errors, (like global positioning errors are considered).

In Step 230, an estimate will be calculated of the position and movement. Some of this information can, for example include calculating speed information and changing traffic conditions such as traffic congestion information of the candidate surrounding roads from the estimated position. This also includes, in an embodiment, the road, direction and speed information of other vehicles in the proximity of time that are being tracked by the system including applications used such as CVI.

In Step 240, the real-time effectiveness is calculated and defined for each road. In one embodiment, this can be defined as the effectiveness of the estimate based on the number of vehicles used and the time elapsed (effectiveness become lower if the used other vehicle information is old since we focus on real-time usage).

In an embodiment, there is consideration given to lag time and other related information. In one embodiment, past records are considered as well. When past historical data is available, such as used in Step 242, any such probe information is used such as previous speed and other traffic information that may lower the effectiveness values.

In Step 242, all information is used in determination of different effectiveness for each available candidate (selection). In an embodiment, using past or current estimated speed, dynamic traffic changes and congestion, and direction information with different effectiveness is considered.

In Step 250 the precise position of the vehicle is provided and when appropriate and output is generated relating not this. In an embodiment, the output may most likely be the road that the target vehicle is traveling on based on the vehicle's position, speed and direction information.

In one embodiment, the target vehicle may also be in communication with other vehicles or other technology that provides estimated information. In that case, the additional information provided may be added to the estimated information to the system's tracking information. This is shown as optional Step 245. This consideration will also be inputted in the final output.

In one embodiment, the process 200 can improve the accuracy of road detection in real-time sensor information (GPS information and speed information) analysis in CVI (Connected Vehicle Information) by adding not only self-vehicle data but also a large amount of other vehicle information collected by CVI to the analysis. Furthermore, the process can be further complemented by utilizing V2V (Vehicle-to-Vehicle) communication to share information between vehicles estimated to be traveling on the same road, thereby enhancing the accuracy of the road detection. This resolves the inaccuracies of previous art that only probe information (time, latitude and longitude, speed) sent from a single vehicle or a collection of vehicles not related to a time range or location and map information are used to estimate the road on which the vehicle is traveling. In such cases, due to position information, errors in the probe information, incorrect roads are often output, which can be problematic for real-time services.

The process 200 can provide focus on real-time vehicle data integration using such technology as applications such as CVI. Process 200 may utilize the estimated results of nearby vehicles'data (position, speed, traffic congestion, and identified road) that have traveled, relatively in close proximity, to improve its own estimation. The process 200 may also take into account the possibility that the traffic congestion and speed conditions may have changed over time, and accordingly, it assigns lower priority to older information and weights it less in the estimation process.

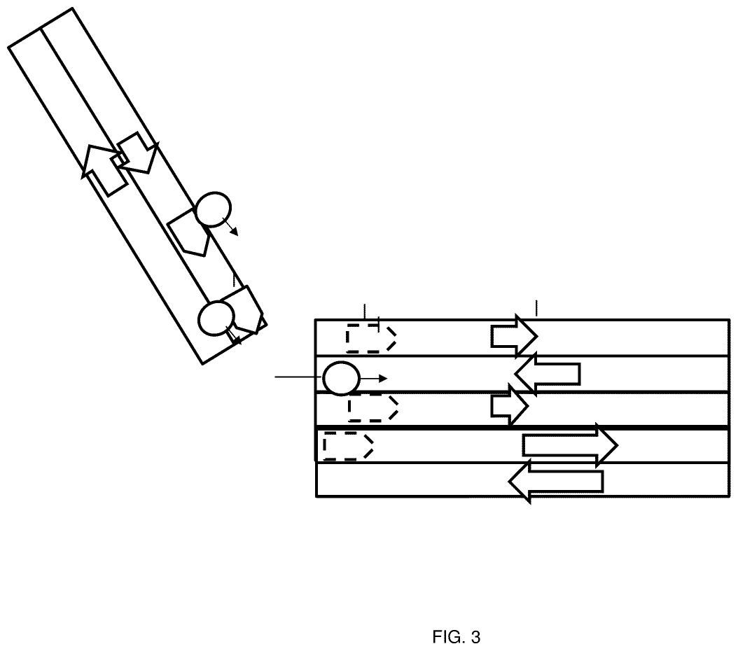

FIG. 3 provides an example of the workings of the process 200. In the block diagram illustrated, the candidate position is shown as 310 at the start of the process. The pentagon that has the dotted outline is the current position of the vehicle as shown at 310. The arrow 320 shows the road speed information obtained from other vehicles. The previous/past locations are denoted by circles 330, 332 and 334. New speed position and GPS can be provided as shown at 312, and 314. In the portion of the diagram referenced as 350, past location of a vehicle 360, present location 365 (having new GPS position and speed information) is provided.

In FIG. 3, the process stores the speed and direction information of the surrounding roads from vehicle data (GPS, speed, direction) in the proximity of time that are being tracked by the system including CVI. This is to Improve accuracy of estimation by considering the stored speed and direction information when estimate the position and road with newly obtained vehicle data.

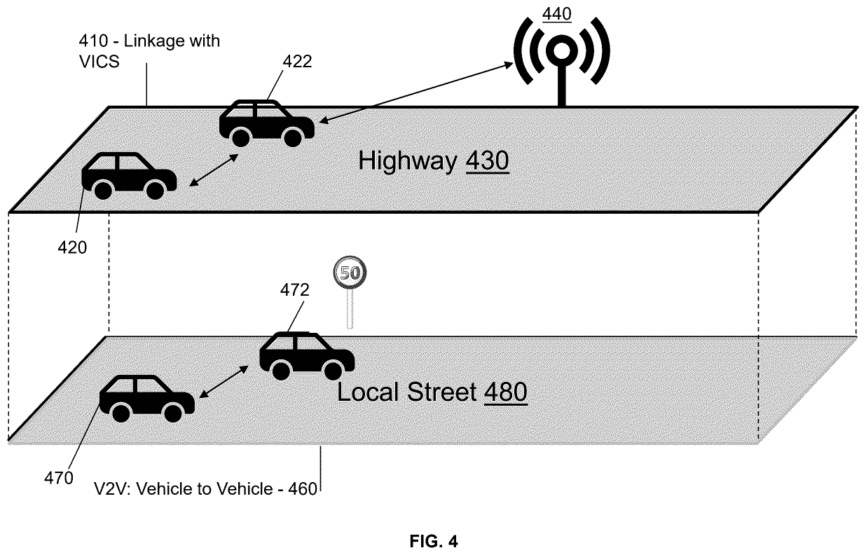

FIG. 4 provides an embodiment that uses a VICS. “VICS” is a system that delivers road traffic information, such as traffic congestion and traffic regulations, to car navigation systems in real time using FM multiplex broadcasts and beacons. VICS information is provided 24 hours a day, 365 days a year, and is used by car navigation systems to search routes and avoid traffic jams.

In an embodiment, shown as 410, cars 420 and 422 travelling on a highway 430 are receiving information via o VICS 440. In this embodiment (Linkage with VICS) roads are identified by d discrepancies between information and vehicle speed, such as vehicle speeds despite receiving traffic congestion information. Since beacons are generally placed on highways, this is identified the road the vehicle is now on as a highway because of the information provided by the beacon.

In a second embodiment, as referenced by 460, the two cars 470 and 472 travelling on a local street 480 are connected via a vehicle to vehicle (V2V) linkage. In the embodiment where the Linkage is with V2V (Vehicle-to-Vehicle) communication, the process improve the accuracy of road identification by utilizing V2V (Vehicle-to-Vehicle) communication to share information between vehicles estimated to be traveling on the same road, thereby enhancing the accuracy of the road detection. This information obtained from other vehicles can be added to the system (CVI) tracking data.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for determining precise location of a target vehicle dynamically, comprising:
obtaining a plurality of data relating a target vehicle to determine said target vehicle's position and route, wherein said plurality of data relates to said target vehicle's speed and general moving and directional position;
calculating an estimate based on information about target vehicle movement using speed and traffic congestion based on position of said target vehicle;
obtaining information about movement of a plurality of other vehicles in proximity of said target vehicle;
determining an elapsed time difference between a progress of movement of said target vehicle and a real-time progress of said plurality of other vehicles;
calculating an estimate based on said elapsed time difference and a time difference between said target vehicle real-time progress and one or more previous recorded historical data time-stamp(s);
determining said target vehicle's precise position based on said effectiveness estimate.

2. The method of claim 1, further comprising updating said estimate based on new information received regarding progress of said target vehicle or said one or more other vehicles.

3. The method of claim 2, wherein updating of said estimate is also based on dynamic information obtained from said plurality of other vehicles regarding traffic congestion on one or more or a plurality of roads, and direction of travel information.

4. The method of claim 1, further comprising:
generating an output, wherein said output provides said estimate and a most likely road that said target vehicle is located on based on the vehicle's position, speed and direction information.

5. The method of claim 4, further comprising:
determining number of a plurality of vehicles used and an associated time elapsed with them to lower an effectiveness factor associated with said update;
generating a new output using each effectiveness estimate, wherein said estimate changes based on the number of vehicles used for obtaining data.

6. The method of claim 1, wherein said data is received from a connected vehicle insight (CVI) network having data of current and past vehicles travelling on a similar path.

7. The method of claim 1, wherein said data is obtained through the target vehicle communicating with other vehicles when using a vehicle-to-vehicle network.

8. A computer system for determining precise location of a target vehicle dynamically, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps;
obtaining a plurality of data relating a target vehicle to determine said target vehicle's position and route, wherein said plurality of data relates to said target vehicle's speed and general moving and directional position;
calculating an estimate based on information about target vehicle movement using speed and traffic congestion based on position of said target vehicle;
obtaining information about movement of a plurality of other vehicles in proximity of said target vehicle;
determining an elapsed time difference between a progress of movement of said target vehicle and a real-time progress of said plurality of other vehicles;
calculating an estimate based on said elapsed time difference and a time difference between said target vehicle real-time progress and one or more previous recorded historical data time-stamp(s);
determining said target vehicle's precise position based on said effectiveness estimate.

9. The computer system of claim 8, further comprising updating said estimate based on new information received regarding progress of said target vehicle or said one or more other vehicles.

10. The computer system of claim 9, wherein updating of said estimate is also based on dynamic information obtained from said plurality of other vehicles regarding traffic congestion on one or more or a plurality of roads, and direction of travel information.

11. The computer system of claim 8, further comprising:
generating an output, wherein said output provides said estimate and a most likely road that said target vehicle is located on based on the vehicle's position, speed and direction information.

12. The computer system of claim 11, further comprising:
determining number of a plurality of vehicles used and an associated time elapsed with them to lower an effectiveness factor associated with said update;
generating a new output using each effectiveness estimate, wherein said estimate changes based on the number of vehicles used for obtaining data.

13. The computer system of 8, wherein said data is received from a connected vehicle insight (CVI) network having data of current and past vehicles travelling on a similar path.

14. The computer system of 8, wherein said data is obtained through the target vehicle communicating with other vehicles when using a vehicle-to-vehicle network.

15. A computer program product for determining precise location of a target vehicle dynamically, comprising:
one or more computer-readable storage medium and program instructions stored on at least one of the one or more tangible storage medium, the program instructions executable by a processor, the program instructions comprising:
obtaining a plurality of data relating a target vehicle to determine said target vehicle's position and route, wherein said plurality of data relates to said target vehicle's speed and general moving and directional position;
calculating an estimate based on information about target vehicle movement using speed and traffic congestion based on position of said target vehicle;
obtaining information about movement of a plurality of other vehicles in proximity of said target vehicle;
determining an elapsed time difference between a progress of movement of said target vehicle and a real-time progress of said plurality of other vehicles;
calculating an estimate based on said elapsed time difference and a time difference between said target vehicle real-time progress and one or more previous recorded historical data time-stamp(s);
determining said target vehicle's precise position based on said effectiveness estimate.

16. The computer program product of claim 15, further comprising updating said estimate based on new information received regarding progress of said target vehicle or said one or more other vehicles.

17. The computer program product of claim 16, wherein updating of said estimate is also based on dynamic information obtained from said plurality of other vehicles regarding traffic congestion on one or more or a plurality of roads, and direction of travel information.

18. The computer program product of claim 17, further comprising:
generating an output, wherein said output provides said estimate and a most likely road that said target vehicle is located on based on the vehicle's position, speed and direction information.

19. The computer program product of claim 18, further comprising:
determining number of a plurality of vehicles used and an associated time elapsed with them to lower an effectiveness factor associated with said update;
generating a new output using each effectiveness estimate, wherein said estimate changes based on the number of vehicles used for obtaining data.

20. The computer program product 15, wherein said data is received from a connected vehicle insight (CVI) network having data of current and past vehicles travelling on a similar path.
